(19) United States
(12) Patent Application Publication
(10) Pub. No.: US 2019/0198238 A1
(43) Pub. Date: Jun. 27, 2019

(54) THREE-PHASE TRANSFORMER

(71) Applicant: U.T.T. UNIQUE TRANSFORMER TECHNOLOGIES LTD, Or Akiva (IL)

(72) Inventors: Eliezer ADAR, Herev La Et (IL); Yuri BOLOTINSKY, Netanya (IL)

(21) Appl. No.: 16/311,390

(22) PCT Filed: Jun. 22, 2017
(86) PCT No.: PCT/IL2017/050695

§ 371 Date: Dec. 19, 2018

(30) Foreign Application Priority Data
Jun. 22, 2016 (IL) 246466

(51) Int. Cl. H01F 30/12; H01F 27/28; H01F 27/24; H01F 41/02; H01F 41/04; H01F 41/12; H01F 27/32

(52) U.S. Cl. CPC H01F 30/12; H01F 27/28; H01F 27/24; H01F 27/324; H01F 41/04; H01F 41/12; H01F 41/0206

(57) ABSTRACT

A three-phase transformer, and method of assembling the same, are disclosed. The three-phase transformer comprises three closed-loop magnetic core elements each comprising two pairs of partial primary and secondary coils respectively associated with two different electrical phases of the three-phase transformer. Each pair of partial primary and secondary coils is placed over a same magnetic core section of its closed-loop magnetic core element and its partial primary and secondary coils are respectively electrically connected either in series or in parallel to partial primary and secondary coils of another pair of partial primary and secondary coils associated with the same electrical phase and placed over another one of the closed-loop magnetic core elements. The serially or parallelly electrically connected partial primary coils are electrically coupled for connection to a three-phase electric power supply. The serially or parallely electrically connected secondary coils are electrically coupled for connection to a three-phase load.

### TECHNOLOGICAL FIELD

The present application is generally in the field of three-phase transformers.

### BACKGROUND

An electrical transformer is an electrical device comprising one or more primary and secondary windings inductively coupled such that an AC (alternating power) input electric power in primary winding(s) thereof induces a respective output AC electric power in secondary winding(s) thereof.

A three-phase transformer typically comprises a magnetic-core circuit and three coil blocks inductively coupled to the magnetic-core circuit. Each one of the coil blocks usually consists of primary and secondary windings. State of the art three-phase electrical transformers usually utilize the so called “E+1” magnetic core configuration, where the coils are mounted over the three legs of “E” shaped frame of the magnetic core that is thereafter closed by “1” shaped yoke of the core. As such, the “E+1” magnetic core configuration provides a planar core structure.

Japanese patent publication No. JPS5928310A2 describes a three-phase transformer, which consists of three single-phase magnetic transformers, each constituted in such a manner that a plurality of coil spools, on which primary coils and secondary coils are wound, are arranged on the circumferences of the wound cores consisting of amorphous material at regular intervals. A three-phase transformer proper is constituted in such a manner that these single-phase transformers are disposed on the same axis through insulating space plates and each single-phase transformer coil is thee-phase connected. According to such constitution, the brittle fracture of the core resulting from brittleness on the quality of material of the amorphous magnetic material can be prevented. This type of transformer design is however of complex structure due to the location of sectional alternate high and low voltage terminals thereof, as the distance between these terminals depends on the voltage level. Furthermore, each section of high voltage coil should have a more powerful insulation, which makes it difficult to install such terminals on a toroid made of an amorphous ribbon.

U.S. Pat. No. 4,893,069 describes a ferroresonant three-phase constant AC voltage transformer comprising three transformer iron cores with one for each corresponding input supply phase, primary windings and secondary windings formed on each of the transformer iron cores, series reactance components or reactors connected in series, with the primary windings, automatic voltage regulating means for controlling secondary output voltages generated at the secondary windings to a predetermined target value, compensating windings formed so as to be inductively coupled to each of the series reactance components or reactors, and means for connecting the compensating windings in series with each other to form a closed loop circuit. The secondary output voltages are theoretically kept in balanced condition even when the loads or the primary input voltages or both are unbalanced.

In U.S. Pat. No. 4,862,059 primary and secondary windings of each transformer in a three-phase system each form a pair of independent windings, the first winding of each of the primary and secondary pairs formed on the iron core of one of the transformers and the second winding of each of the primary and secondary pairs formed on the iron core of the transformer adjacent thereto are connected in series to each other. These serially connected windings are regarded as one phase winding respectively, and they are connected to each other in either a delta connection or a Y connection. A variation in the voltage phase caused by a change in the load current of one of the system outputs has an influence not only on the phase of the voltage at that output but also on the phase of the voltages on the outputs adjacent thereto and consequently enables the deviation in the phase difference between the output phase voltages due to loss of balance of the load to be decreased to about one half. When the leg parts of two adjacent iron cores are juxtaposed and a common winding is formed on the juxtaposed leg parts so that one winding may function equivalently as two windings connected in series, the number of windings required in all is one half of the number of windings required where the windings are formed independently on the leg parts of the cores.

### General Description

Conventional three-phase transformers typically utilize a magnetic core system configured to define magnetic core legs having relatively large cross-sectional areas, which consequently require three primary windings/coils and three secondary windings/coils having correspondingly relatively large inner and outer diameters for placement over the magnetic core legs. Such conventional three-phase transformer designs are thus inevitably bulky, heavy, and of relatively large geometrical dimensions.

The present application discloses three-phase transformer designs that can be flexibly arranged to fit into relatively small spaces, or distributed for placement of components thereof in several different locations that can be relatively remote one from the other, and having relatively smaller weights and geometrical dimension. The three-phase transformer according to some embodiments comprises three separate closed-loop magnetic core elements, where each closed-loop magnetic core element comprises two pairs of partial primary and secondary windings/coils respectively associated with two different electrical phases of a three-phase electrical supply, and where each pair of partial primary and secondary windings/coils is located over the same section of its closed-loop magnetic core element.

Each pair of partial primary and secondary windings/coils is electrically connected to windings/coils of another pair of partial primary and secondary windings/coils located on another closed-loop magnetic core element of the three-phase transformer and associated with the same electrical phase. More particularly, in each pair of partial primary and secondary windings/coils the partial primary windings/coil is electrically connected in series, or in parallel, to the partial primary windings/coil of the other pair of partial primary and secondary windings/coils located on the other closed-loop magnetic core element and associated with the same electrical phase, and the partial secondary windings/coil is electrically connected in series, or in parallel, to the partial secondary windings/coil of the other pair of partial primary and secondary windings/coils located on the other closed-loop magnetic core element and associated with the same electrical phase.

In this way, the primary and secondary windings associated with each electrical phase of the three-phase transformer are distributed over two different magnetic core elements, while defining in each magnetic core element a magnetic core section associated with one electric phase of a first pair of partial primary and secondary winding/coils thereof, and another magnetic core section associated with another electric phase of a second pair of partial primary and secondary winding/coils thereof. In this way, the magnetic interaction/coupling typically required between the magnetic core elements in the conventional three-phase transformers is replaced by the electrical interaction/coupling between the serially, or parallelly, connected partial primary windings/coils and the serially, or parallelly, connected partial secondary windings/coils. This distribution of the primary and secondary windings of the different electrical phases among the magnetic core elements enable three-phase transformer designs wherein each magnetic core element is placed independently and separately in three-dimensional space, thus permitting relatively large distances between the magnetic core elements.

In some embodiments the serially, or parallelly, connected secondary windings/coils are electrically connected to each other to form a star circuit electrically connectable to a three-phase load of the three-phase transformer, and the serially, or parallelly, connected primary windings are electrically connected to each other to form a delta circuit electrically connectable to a three-phase electrical power supply of the three-phase transformer. In some alternative embodiments the serially, or parallelly, connected secondary windings/coils are electrically connected to each other to form a delta circuit electrically connectable to a three-phase load of the three-phase transformer, and the serially, or parallelly, connected primary windings are electrically connected to each other to form a star circuit electrically connectable to a three-phase electrical power supply of the three-phase transformer.

Accordingly, the three-phase transformer of some embodiments comprises three identical separate transformer blocks which are mounted with the ability to movably change their relative position. Each transformer block can comprise a closed-loop magnetic core element (e.g., made from ferromagnetic material, such as, amorphous metal, amorphous alloy and nanocrystalline alloy) optionally having a transverse slit, two pairs of coils formed on each closed-loop magnetic core element, wherein each pair of coils of the magnetic core element is associated with a different electrical phase and comprises a partial primary windings/coil and a partial secondary windings/coil that are coaxially disposed over a magnetic core section of the closed-loop magnetic core element. Each partial primary windings/coil, and each partial secondary windings/coil, formed on each closed-loop magnetic core element, is electrically connected in series, or parallel, to a corresponding partial windings/coil associated with the same electric phase and locate on a closed-loop magnetic core of another transformer block.

Optionally, and in some embodiments preferably, each pair of partial primary and secondary windings/coils associated the same electrical phase is concentrically disposed over a magnetic core section of its closed-loop magnetic core element. In some possible embodiments, in each pair of partial primary and secondary windings/coils, the windings of the partial primary coil are placed/formed over the windings of the partial secondary coil, such that the partial secondary windings/coil is sandwiched between the magnetic core section of closed-loop magnetic core element and the windings of the partial primary coil.

In this way the transverse cross-section (i.e., the cross sectional area) of each closed-loop magnetic core element can be selected to be about one half of a transverse cross-section of the magnetic core calculated for one electrical phase of a conventional three-phase transformer designed to operate with the same high and low voltages and electric currents. Optionally, and in some embodiments preferably, the number of turns in each partial primary and secondary windings/coil is half of the number of turns calculated for one electric phase of a conventional three-phase transformer designed to operate with the same high and low voltages and electric currents.

These features enable the construction of three-phase transformers having substantially reduced geometrical dimensions, and consequently also substantial reduction in the weight of the transformer, compared to geometrical dimensions and weight of three-transformers complying with international standards for three-phase transformers and designed to operates under the same voltages and/or currents. Particularly, since the cross-sectional areas of the closed-loop magnetic core elements is reduced by about 50%, the inner and outer diameters of the primary and secondary windings/coils disposed over the core elements are correspondingly reduced. Further reduction of the inner and outer diameters of the primary and secondary windings/coils is obtained by concentrically placing each pair of primary and secondary windings/coils associated with the same electrical phase one over the other, which also maximizes and optimize the distribution the coils windings along the closed-loop magnetic core elements and the utilization their outer surface areas. Consequently, the reductions in the cross-sectional areas of the closed-loop magnetic core elements and in the inner and outer diameters of the windings/coils results in significant reduction in the amount of materials required to construct the three-phase transformers, and thus also significant reduction of the overall weight of the transformer.

In some embodiments, in order to obtain a compact arrangement of the transformer blocks, the transformer blocks are mounted side-by-side one parallel to the other with a minimum distance between them (e.g. few millimeters or few tens of millimeters), and such that the front/wide dimension faces of their closed-loop magnetic core elements are parallel one to the other (i.e., the planes of the closed-loop magnetic core loop elements are spaced apart and parallel one to the other and their centers are placed spaced apart along a common axis). In some embodiments the closed-loop magnetic core loop elements are rectangular ring shaped elements, and the transformer blocks are mounted side-by-side one parallel to the other such that vertical axes of their closed-loop magnetic core loop elements are located in one same plane. Alternatively, in some embodiments the transformer blocks are arranged separately with relatively large distances between them.

Optionally, and in some embodiments preferably, each closed-loop magnetic core element is made from wound magnetic material ribbon, such as, but not limited to, amorphous or nanocrystalline ribbon. Alternatively, in some embodiments each closed-loop magnetic core element is made from silicon steel. Each closed-loop magnetic core element can be impregnated with an insulating material, such as, but not limited to, epoxy resin. Furthermore, each closed-loop magnetic core element can be wound from magnetic material ribbons having same ribbon width, or alternatively, from a set of magnetic cores each of which is wound from magnetic material ribbon having the same or a different width.

Optionally, the number of transformer blocks in the three-phase transformer is greater than three, but being a multiple of three e.g., 6, 9, 12, 24, etc., wherein pairs of partial primary and secondary coils of each triplicate of (three) transformer blocks are electrically connected in series, or in parallel, to pairs of partial primary and secondary coils of a similar group/triplicate of (three) transformer blocks, depending on the operating voltage and power.

One inventive aspect of the subject matter disclosed herein relates to a three-phase transformer comprising three closed-loop magnetic core elements each comprising two pairs of partial primary and secondary coils respectively associated with two different electrical phases of the three-phase transformer. Each pair of partial primary and secondary coils is placed over a same magnetic core section of its closed-loop magnetic core element and its partial primary and secondary coils are respectively electrically connected either in series or in parallel to partial primary and secondary coils of another pair of partial primary and secondary coils associated with the same electrical phase and placed over another one of the closed-loop magnetic core elements. The serially or parallelly electrically connected partial primary coils are electrically coupled for connection to a three-phase electric power supply, and the serially or parallely electrically connected secondary coils are electrically coupled for connection to a three-phase load.

Optionally, and in some embodiments preferably, the connected primary coils are electrically connected to each other to form a delta circuit electrically connectable to the three-phase electrical power supply, and the connected secondary coils are electrically connected to each other to form a star circuit electrically connectable to the three-phase load. Alternatively, in some embodiments, the connected primary coils are electrically connected to each other to form a star circuit electrically connectable to the three-phase electrical power supply, and the connected secondary coils are electrically connected to each other to form a delta circuit electrically connectable to the three-phase load.

The partial primary and secondary coils of each pair of partial primary and secondary coils can be coaxially mounted one over the other. Optionally, and in some embodiments preferably, in each pair of partial primary and secondary coils the primary coil is mounted concentrically over the secondary coil.

Optionally, and in some embodiments preferably, the closed-loop magnetic core elements are positioned side-by-side one parallel to the other such that their wide dimension faces are substantially parallel to each other. In this transformer arrangement the distance between adjacently located closed-loop frames is minimized to define a predetermined small gap (e.g., of about 25 mm) between adjacently located partial coils. Each closed-loop magnetic core element can have a substantially rectangular ring shape, and the closed-loop magnetic core element can be compactly arranged side-by-side one parallel to the other to form a generally rectangular prism shape three-phase transformer. Alternatively, in some embodiments the closed-loop magnetic core elements are placed relative remote one from the other.

The cross-sectional area of each closed-loop magnetic core element can be set to be about half of a cross-sectional area computed for an electrical phase of a three-phase transformer designed to operate with same high and low voltages and electric currents of the three-phase transformer according to standard specifications for three-phase transformers. Additionally, or alternatively, the sum of turns in each of the serially or parallelly connected partial primary coils equals to a number of primary turns calculate for an electric phase of a three-phase transformer designed to operate with same high and low voltages and electric currents of the three-phase transformer according to standard specifications for three-phase transformers, and wherein the sum of turns in each of the serially or parallelly connected partial secondary coils equals to a number of secondary turns calculate for the electric phase of the three-phase transformer designed to operate with same high and low voltages and electric currents of the three-phase transformer according to the standard specifications for three-phase transformers.

In some possible embodiments the number of turns in each partial primary coil is half of the calculated number of primary turns for the electrical phase of the three-phase transformer designed to operate with same high and low voltages and electric currents of the three-phase transformer according to the standard specifications for three-phase transformers. Similarly, the number of turns in each partial secondary coil can be half of the calculated number of secondary turns for the electrical phase of the three-phase transformer designed to operate with same high and low voltages and electric currents of the three-phase transformer according to the standard specifications for three-phase transformers.

In some embodiments the cross-sectional shape of the closed-loop magnetic core elements is rectangular. Accordingly, sectional shape of the coils can also be rectangular.

Another inventive aspect of the subject matter disclosed herein relates to a three-phase transformer comprising two or more triplicates of transformer blocks, each triplicate of transformer blocks comprises partial primary and secondary coils arranged on three different closed-loop magnetic core elements that are electrically connected as described hereinabove, and the two or more triplicates of transformer blocks are electrically coupled to each other to form either serial or parallel electrical connection between their coils.

Yet another inventive aspect of the subject matter disclosed herein relates to a method of manufacturing a three-phase transformer, the method comprising preparing three closed-loop magnetic core elements, cutting and removing a section of each magnetic core element, placing two inner coils over two different core sections of each magnetic core element, placing an external coil over each inner coil, attaching to each magnetic core element its respective removed section, electrically connecting each inner and outer coils belonging to the same magnetic core section to respective inner and outer coils belonging to a same magnetic core section of another magnetic core element, electrically coupling between the outer coils for connection thereof to a three-phase power supply, and electrically coupling between the inner coils for connection thereof to a three-phase load.

Optionally, and in some embodiments preferably, the method comprising mounting the closed-loop magnetic core elements with their partial primary and secondary coils side-by-side one parallel and in proximity to the other. Alternatively, in some embodiments the method of comprising placing the closed-loop magnetic core elements with their partial primary and secondary coils one relative remote from the other.

The preparing of the three closed-loop core elements can comprise winding magnetic material ribbon. Optionally, the method comprises impregnating the closed-loop magnetic core elements with a resin material. The method comprises in some embodiments placing electrically insulting spacers between the inner and outer coils.

Optionally, and in some embodiments preferably, the electrically coupling between the outer coils comprises electrically connecting the coils to form a delta circuit. In this configuration, the electrically coupling between the inner coils can comprise electrically connecting the coils to form a star circuit.

Alternatively, in some embodiments, the electrically coupling between the outer coils comprises electrically connecting the coils to form a star circuit. In this configuration the electrically coupling between the inner coils comprises electrically connecting the coils to form a delta circuit.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIG. 1 schematically illustrate a single-phase transformer which magnetic core is based on the “E+1” structure;

FIG. 2 schematically illustrate electrical connection of the secondary winding coils in a three-phase transformer according to some possible embodiments;

FIG. 3 schematically illustrate electrical connection of the primary winding coils in a three-phase transformer according to some possible embodiments;

FIGS. 4A to 4D schematically illustrate elements of a transformer block according to some possible embodiments, wherein FIG. 4A shows front and side sectional views of a closed-loop core element, FIG. 4B shows a perspective view of a transformer block, FIG. 4C shows a top sectional view of the transformer block, and FIG. 4D shows a perspective view of three transformer blocks of FIG. 4B mounted side-by-side one parallel to the other about a common axis;

FIGS. 5A, 5B and 5C, respectively show front, side, and cross-sectional views of a three-phase transformer according to some possible embodiments;

FIG. 6 schematically illustrates a three-phase transformer according to some possible embodiment wherein the partial windings/coils are electrically connected in parallel; and

FIG. 7 is a flowchart illustrating a process of fabricating a three-phase transformer according to some possible embodiments.

### DETAILED DESCRIPTION OF EMBODIMENTS

One or more specific embodiments of the present application will be described below with reference to the drawings, which are to be considered in all aspects as illustrative only and not restrictive in any manner. In an effort to provide a concise description of these embodiments, not all features of an actual implementation are described in the specification. Elements illustrated in the drawings are not necessarily to scale, or in correct proportional relationships, which are not critical. Emphasis instead being placed upon clearly illustrating the principles of the invention such that persons skilled in the art will be able to make and use the disclosed devices, once they understand the principles of the subject matter disclosed herein. This invention may be provided in other specific forms and embodiments without departing from the essential characteristics described herein.

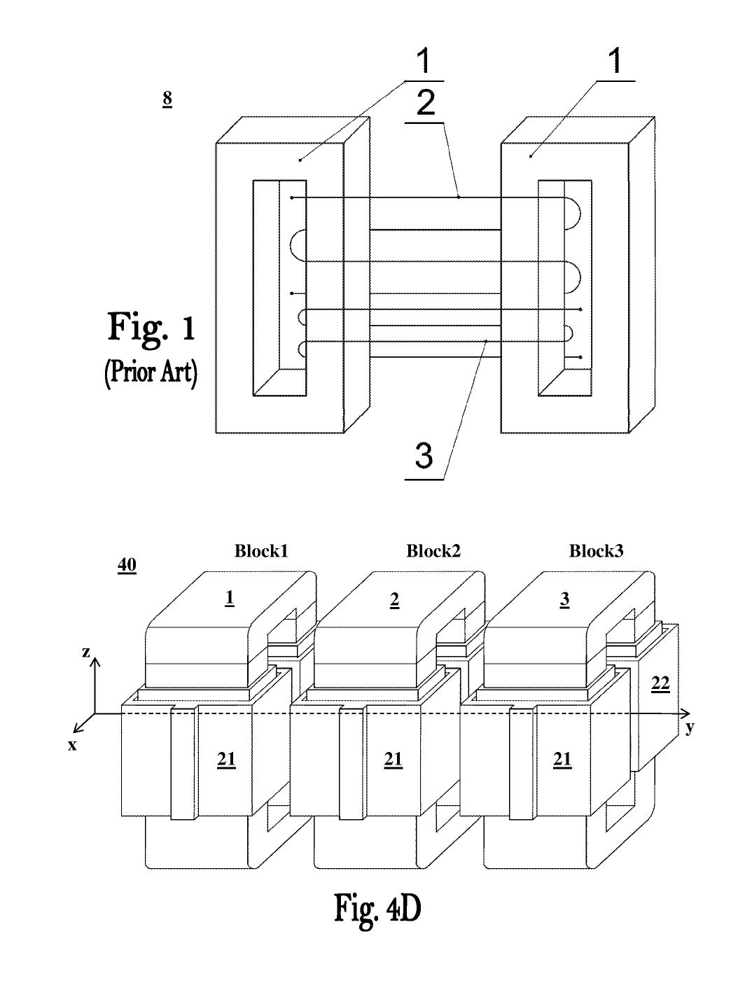

The present application discloses three-phase transformer designs, usable for various applications, such as, but not limited to, three-phase distribution transformers. Single-phase armored transformers having the “E+1” structure, with their windings arranged on the central core, are known in the art. As shown in FIG. 1, the magnetic system of a single-phase transformer 8 may comprise two [symbol] -shaped cores 1, as shown in FIG. 1, having primary windings 2 and secondary windings 3 formed on one side of each magnetic core 1. Three such single-phase transformer structures 8 can be used to assemble a three-phase transformer usable for the three-phase transmission lines. Such three-phase transformer assemblies typically also arranged to form a planar system. The disadvantage of this three-phase transformer design is its relatively large size/geometrical dimensions, heavy weight and large core losses.

A three-phase transformer according to embodiments disclosed herein comprises a three-phase magnetic core circuit that is constructed from three separate and independent magnetic core loops (also referred to herein as magnetic core elements), that can be disposed side-by-side one parallel to the other with short distances between each pair of adjacently located magnetic core elements (e.g., 1 to 50 mm), or separated relatively remote one from the other (e.g., 0.5 to 100 meters) in other suitable arrangements i.e., not necessarily coaxially and/or in any suitable orientation one relative to the other in three dimensional space. Optionally, and in some embodiments preferably, the magnetic core elements of the three-phase transformer are substantially identical at least with respect to their geometrical dimensions, materials compositions, and structural assembly.

Embodiments of the three-phase transformers disclosed herein can be easily adapted to satisfy the requirements/demands currently made for this type of transformers. Particularly, three-phase transformers embodiments of the present application are particularly suitable for new types of electrical power stations that are being put to use nowadays, such as solar or wind power stations, in which strict requirements to the level of transformers losses are made. These electrical power stations usually also require their power transformers to be located in close proximity to their electrical generators, which in turn dictates strict requirements for the geometrical dimensions and shape of the transformers.

Embodiments of the three-phase transformers disclosed herein are accordingly devised to provide:
substantially low level of losses in the magnetic core circuit;
substantially light weight magnetic core circuit(s);
relatively small geometrical dimensions of the transformer and its magnetic core;
the ability to place the transformer in the premises/facility with minimal volume occupation e.g., in a concrete locker of a wind power station.

For example, embodiments disclosed herein can provide relatively compact three-phase transformers. For example, in some embodiments the three-phase transformer power is of 630 kVA having geometrical dimensions of about 1210 mm×1300 mm×760 mm, weight of about 1350 Kg, and magnetic core losses of about 611 W. It is noted that conventional transformers of 630 kVA typically have geometrical dimensions of about 1600 mm×1590 mm×1820 mm, weight of about 2200 Kg, and magnetic losses of about 1380 W. In addition, possible embodiments of the three-phase transformers of the present application can easily fit the transformer practically in any volume since its transformer blocks can be easily and readily installed at separate locations, optionally with the transformer blocks being located one relatively remote from the other in three dimensional space. The distance between the transformer blocks can be up to few meters e.g., 1 to 10 meters, in some embodiments, or few tens of meters in some other possible embodiments e.g., 10 to 100 meters.

This modular structure of the three-phase transformer, which is comprised of several separate and substantially identical transformer blocks that can be compactly disposed one proximal to the other, can be advantageously used to construct three-phase transformers having substantially small geometrical dimensions e.g., having cubic, cuboid, cylindrical, or any suitable equilateral polygon prism three dimensional shape. Accordingly, the transformer blocks can be arranged in parallel side-by-side relationship to reduce the entire size of the three-phase transformer. In these embodiments adjacently located transformer blocks are positioned side-by-side one parallel to the other such that their wide dimension profiles of their closed-loop core elements, are facing and parallel one to the other, such that their vertical axes are located in the same geometrical plane.

In some embodiments an optimal number of the transformer block units of the three-phase transformer is set to three′. In this case, by using a common frame and/or other structural components to fixedly hold/enclose the transformer blocks in a parallel side-by-side relationship, a desired solidity of the three-phase transformer, as well as, easy installation in existing concrete lockers of facilities such as wind power stations, can be also achieved.

It is noted that the minimum distance between the transformer blocks depends on the operating voltage of the windings. For example, at an operating voltage of 22 kV (kilovolts) on the primaries, this distance can be set to about 25 mm.

By arranging the transformer blocks separately, e.g., at relatively large distances from each other, it is possible to place them in different separate lockers/compartments of the minimum sizes/geometrical dimensions, with a minimum distance from the walls of the locker/compartment that depends on the operating voltage on the primary windings. For example, at an operating voltage of 22 Kv on the primaries, this minimum distance can be set to about 25 mm.

In possible embodiments each transformer block of the three-phase transformer comprises a closed-loop core made from ferromagnetic material, for example, amorphous metal, amorphous alloy or nanocrystalline alloy, silicon steel, and has a transverse slit. In particular, each transformer block can comprise a closed-loop magnetic core element wound from magnetic material, for example, of amorphous or nanocrystalline material tape/ribbon. In embodiments requiring compact arrangement of the transformer blocks the closed-loop magnetic core elements are installed vertically and coaxially, one parallel to the other, in a side-by-side relationship, such their wide dimension faces thereof are facing each other.

Optionally, and in some embodiments preferably, the cross sectional area of the closed-loop magnetic core elements is of a substantially rectangular shape. In some embodiments, after winding the magnetic cores they are impregnated with an insulating material such as epoxy resin. In some embodiments the closed-loop magnetic core elements have transverse slit(s) arranged for easy installation of the partial primary and secondary windings, that can be provided in form of prepared wound coils.

Some advantages of the three-phase transformer embodiments disclosed herein are obtained by using two primary winding/coils and two secondary winding/coils on each one of the magnetic core elements. More particularly, each magnetic core element of the three-phase transformer comprises two partial primary winding/coils and two partial secondary winding/coils. Each partial primary winding/coil in a magnetic core element is associated with a different phase of an electrical power supply of the transformer, and each partial secondary winding/coil of the magnetic core element is associated with a different phase of an electrical power output of the transformer.

In each one/first of the magnetic core elements, each partial primary winding/coil is electrically connected in series, or in parallel, with a respective partial primary winding/coil (of the similar phase) located in a another magnetic core element, to thereby form a full/complete primary winding distributed between two separate and independent first/one and second/another magnetic core elements, and each partial secondary winding/coil in the first magnetic core is electrically connected in series, or in parallel, with a respective partial secondary winding/coil located in a another magnetic core element, to thereby form a full/complete secondary winding/coil distributed over two separate and independent one and other magnetic core elements. In the same way, all primary and secondary partial windings/coils of the respective phases, located on different magnetic elements, are interconnected. Optionally, the partial windings/coils in each magnetic core element are electrically connected to their respective partial windings/coils in the other magnetic core elements by a single bus-bar element or cable. Optionally, and in some embodiments preferably, the three-phase transformer scheme complies with specifications defined in international standards, for example, the IEC 76-1 international standard for power transformers.

Optionally, and in some embodiments preferably, the number of turns in each partial primary winding/coil is half of the calculated number of turns for one phase primary coil of the three-phase transformer according to engineering design considerations of the three-phase transformer for specified transformation ratio and nominal primary and secondary electric currents and/or voltages e.g., as derived from the IEC 76-1 international standard specifications. Similarly, the number of turns in each partial secondary coil is half of the calculated number of turns for one phase secondary coil of the three-phase transformer according to the same engineering design considerations. Of course, any other suitable three-phase transformer standard can be similarly used in construction of the three-phase transformers of the present application. A principal feature of the three-phase transformer embodiments disclosed herein is in that the three-phase transformer does not have a common yoke element for magnetically coupling core elements of its magnetic core circuit, as usually used in conventional three-phase transformer designs.

In some embodiments, the cross-sectional area of each of the magnetic core elements is selected based on the electrical calculations to be about half of the transverse cross section area of the magnetic core area calculated for one electrical phase e.g., according to the above-mentioned international standard, or any other suitable standard specifications.

Each transformer block of the three-phase transformer comprises a close-loop magnetic core element e.g., comprised of a type C-shaped core element closed by a suitable magnetic core circuit closing element, made of amorphous or nanocrystalline ribbon. In some embodiments there are two identical partial secondary windings/coils mounted on each magnetic core element, which are separated by an air gap, or by any other suitable electrically insulating material, from the external surface of the magnetic core element. Optionally, and in some embodiments preferably, on the outer surface area of each partial secondary winding/coil a primary winding/coil is mounted, separated from the external surface of the secondary winding/coil by an air gap, or any other suitable electrically insulating material.

Optionally, and in some embodiments preferably, the close-loop magnetic core elements of the three-phase transformer are made from silicon steel. For example, and without being limiting, the closed-loop magnetic core elements of each transformer block can be wound from magnetic material ribbons having same ribbon width, using any suitable conventional manufacture techniques know in the art. Alternatively, in possible embodiments each closed-loop magnetic core element can be constructed from a set of magnetic core portions, where each of magnetic core portion is wound from a magnetic ribbon material having the same or different width. For the joint work of three such transformer blocks, the partial windings/coils in each block are electrically interconnected by bus bars or cables to partial windings/coils of at least two other transformer blocks, so as to form a full/complete winding/coil of the three-phase transformer.

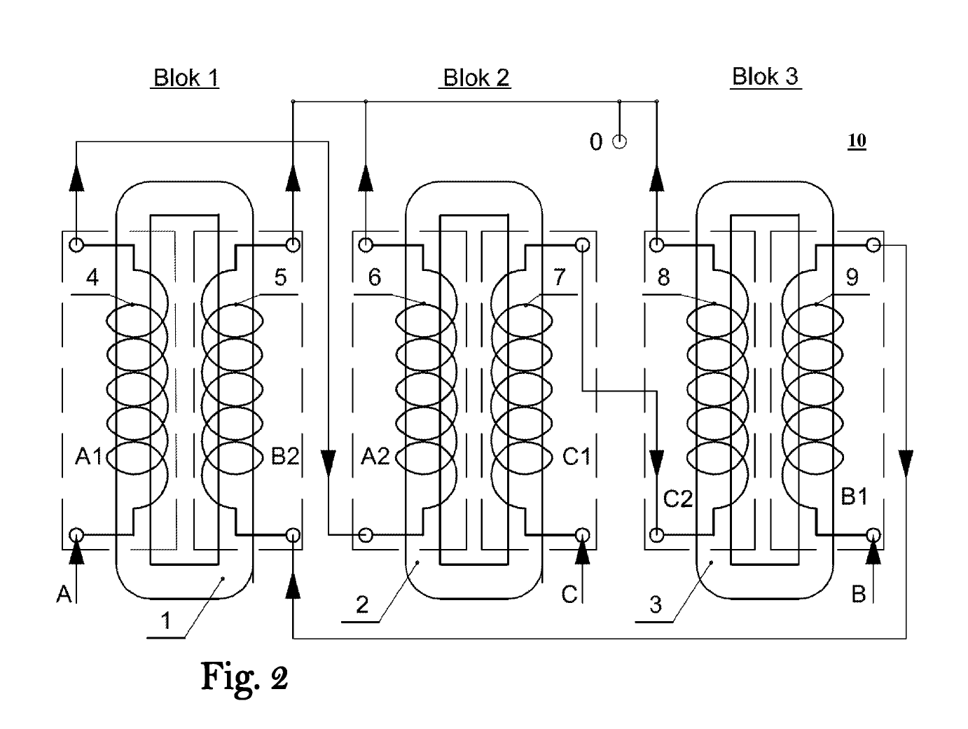

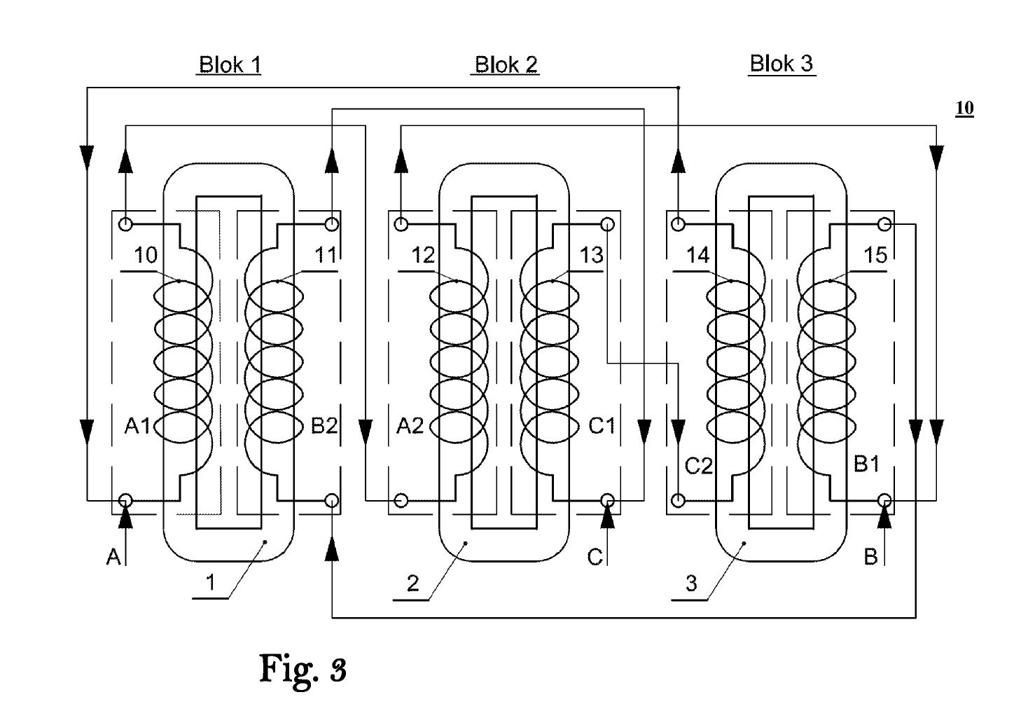

FIGS. 2 and 3 are partial illustrations of a three-phase transformer 10 having according to some possible embodiments three transformer blocks, Block1, Block2, and Block3, each comprising a respective closed-loop magnetic core element, designated by reference numerals 1, 2 and 3, respectively. FIG. 2 schematically illustrates the electrical connectivity of the partial secondary windings/coils of the three-phase transformer 10, and FIG. 3 schematically illustrates the electrical connectivity of the partial primary windings/coils of the three-phase transformer 10.

As seen in FIG. 2, the transformer block Block1 comprises the closed-loop core 1, and the partial secondary windings/coils 4 and 5, the transformer block Block2 comprises the closed-loop core 2 and the partial secondary windings/coils 6 and 7, and the transformer block Block3 comprises the closed-loop core 3 and the partial secondary windings/coils 8 and 9. As will be explained below, the windings of each secondary coil associated with the different electrical phases, ‘A’, ‘B’ and ‘C’, outputted by the three-phase transformer 10, are distributed between at least two of the closed-loop magnetic core elements 1, 2 and 3, of the transformer 10. Accordingly, each section of the magnetic core elements 1, 2 and 3, that is associated with a certain electric phase of the transformer is referenced by a combination of the respective phase and index of ‘1’ or ‘2’, according to its electrical connectivity.

More particularly:
the magnetic core 1 in the transformer block Block1 includes the section A1 comprising the windings/coil 4 that is associated with the electrical phase ‘A’, and the section B2 comprising the windings/coil 5 that is associated with electrical phase ‘B’;
the magnetic core 2 in the transformer block Block2 includes the section A2 comprising the windings/coil 6 that is associated with the electrical phase ‘A’, and the section C1 comprising the windings/coil 7 that is associated with electrical phase ‘C’; and
the magnetic core 3 in the transformer block Block3 includes the section C2 comprising the windings/coil 8 that is associated with the electrical phase ‘C’, and the section B1 comprising the windings/coil 9 that is associated with electrical phase ‘B’.

In some possible embodiments the electrical connectivity of the primary and secondary windings/coils of the three-phase transformer 10 is configured to define delta/star (Δ/Y) circuitries as define in the specifications of the international standard IEC 76-1 for power transformer. In this case the electrical connectivity of the primary windings/coils of the three-phase transformer 10 is selected to form a delta circuit (Δ, triangle), and the electrical connectivity of the secondary windings/coils of the three-phase transformer 10 is selected to form a star circuit (Yn11, star zero output). Therefore, in FIG. 2 the secondary windings of the three phases are connected to form a star circuit, Yn11. Accordingly:
for phase ‘A’, the windings/coil 4 in section A1 of the transformer block Block1 receives at a first terminal provides electrical output of phase ‘A’ and it is electrically connected in series by its second terminal to the windings/coil 6 in section A2 of the transformer block Block2 by a first terminal of the windings/coil 6, and the second terminal of the windings/coil 6 is electrically connected to the ‘0’ point i.e., electrical neutral of the transformer 10;
for phase ‘B’, the windings/coil 9 in section B1 of the transformer block Block3 provides at a first terminal thereof electrical output of phase ‘B’ and it is electrically connected in series by its second terminal to the windings/coil 5 in section B2 of the transformer block Block1 by a first terminal of the windings/coil 5, and the second terminal of the windings/coil 5 is electrically connected to the ‘0’ point of the transformer 10;
for phase ‘C’, the windings/coil 7 in section C1 of the transformer block Block2 provides at a first terminal thereof electrical output of phase ‘C’ and it is electrically connected in series by its second terminal to the windings/coil 8 in section C2 of the transformer block Block3 by a first terminal of the windings/coil 8, and the second terminal of the windings/coil 8 is electrically connected to the ‘0’ point of the transformer 10.

In this way, the secondary windings of each electric phase of the output electric power of the three-phase transformer 10 is distributed between a different pair of two closed-loop magnetic core elements by two respective partial secondary coils. Optionally, and in some embodiments preferably, the number of turns in each partial secondary coil is equal to half (½) of the number of secondary turns calculated for a given phase according to engineering design/specification of the transformer, such that the total number of secondary turns associated with each electrical output phase equals to the number of secondary turns calculated for the given electrical phase i.e., N₄=N₆=NS_{A}/2, N₉=N₅=NS_{B}/2, N₇=N=NS_{C}/2, where N₄, . . . N₉, are positive integers designating the number of turns in the partial windings/coils 4, . . . 9, respectively, and NS_{A}, NS_{B}, and NS_{C}, are positive integers designating the total/calculated number of secondary turns for each of the outputted electrical phases ‘A’, ‘B’ and ‘C’, respectively.

It is thus seen that the total cross sectional area (a) of magnetic core for a given electric phase is the sum of two substantially identical cross sectional areas of the magnetic core elements over which the electric phase is distributed i.e., a=a₁+a₂=a₃+a₁=a₂+a₃, where a₁, a₂, and a₃, are cross-sectional areas of the magnetic core elements 1, 2 and 3, respectively. Optionally, and in some embodiments preferably, the cross-sectional area of each magnetic core element equals to half the cross-sectional area of the magnetic core calculated according to the engineering design/specification of the transformer i.e., a₁=a₂=a₃=a/2.

For example, in a possible embodiment of the three-phase transformer 10 designed for a 630 kVA power, operating frequency of 50 Hz, primary (high) voltage of U1=22 kV and secondary (low) voltage of U2=0.4 kV, the number of turns in each partial secondary windings/coils at A1, B2, A2, C1, C2, and B1 is equal to 11 turns (N₄=N₅=N₆=N₇=N₈=N₉=11), and the cross-sectional area of each of the magnetic core elements 1, 2 and 3, equals to 211.7 cm² in each of the transformer blocks (a₁=a₂=a₃=211.7 cm²) i.e., the number of turns per output electrical phase is NS_{A}=NS_{B}=NS_{C}=22, and the calculated cross-sectional area of the total magnetic core for each electrical phase is a=423.4 cm2.

FIG. 3 schematically illustrate the electrical connectivity of the primary windings/coils provided in the transformer blocks of the three-phase transformer 10. As seen, the magnetic core element 1 of the transformer block Block1 comprises the partial primary windings/coils 10 and 11, the magnetic core element 2 of the transformer block Block2 comprises the partial primary windings/coils 12 and 13, and the magnetic core element 3 of the transformer block Block3 comprises the partial primary windings/coils 14 and 15.

As also seen, the electric phase association of the core sections comprising primary windings/coils corresponds to the electric phase association of the core sections comprising the secondary windings/coils, as shown in FIG. 2. Particularly:
in the transformer block Block1, the core section A1 comprises the windings/coil 10 that is associated with the electric phase ‘A’, and the core section B2 that comprises the windings/coil 11 associated with the electric phase ‘B’;
in the transformer block Block2, the core section A2 comprises the windings/coil 12 that is associated with the electric phase ‘A’, and the core section C1 that comprises the windings/coil 13 associated with the electric phase ‘C’;
in the transformer block Block3, the core section C2 comprises the windings/coil 14 that is associated with the electric phase ‘C’, and the core section B1 that comprises the windings/coil 15 associated with the electric phase ‘B’.

In this specific and non-limiting example, the primary windings/coils are electrically connected to each other to form a delta circuit (A, triangle). Accordingly:
for phase ‘A’, the windings/coil 10 in section A1 of the transformer block Block1 receives at a first terminal thereof electrical input of phase ‘A’ and it is electrically connected in series by its second terminal to the windings/coil 12 in section A2 of the transformer block Block2 by a first terminal of the windings/coil 12, and the second terminal of the windings/coil 12 is electrically connected to the electrical input of phase ‘B’ in of the transformer block Block3;
for phase ‘B’, the windings/coil 15 in section B1 of the transformer block Block3 receives at a first terminal thereof electrical input of phase ‘B’ and it is electrically connected in series by its second terminal to the windings/coil 11 in section B2 of the transformer block Block2 by a first terminal of the windings/coil 11, and the second terminal of the windings/coil 11 is electrically connected to the electrical input of phase ‘C’ in of the transformer block Block2;
for phase ‘C’, the windings/coil 13 in section C1 of the transformer block Block2 receives at a first terminal thereof electrical input of phase ‘C’ and it is electrically connected in series by its second terminal to the windings/coil 14 in section C2 of the transformer block Block3 by a first terminal of the windings/coil 14, and the second terminal of the windings/coil 14 is electrically connected to the electrical input of phase ‘A’ in of the transformer block Block1.

In this way, the primary windings of each electric phase of the input electric power of the three-phase transformer 10 is distributed between a different pair of two magnetic core elements by two respective partial primary coils. Optionally, and in some embodiments preferably, the number of turns in each partial primary coil is equal to half (½) of the number of turns calculated for a given phase according to engineering design/specification of the transformer, as explained hereinabove.

Accordingly, in the above example of the 630 kVA power three-phase transformer having primary (high) voltage of U1=22 kV and secondary (low) voltage of U2=0.4 kV, and operating frequency of 50 Hz, which windings/coils are electrically connected to form the Δ/Yn11 circuit scheme, the number of turns in each of the partial primary coils is 1153, and the calculated number of primary turns for each electric phase is 2306, namely, the N₁₀=N₁₁=N₁₂=N₁₃=N₁₄=N₁₅=1153 turns and NP_{A}=NP_{B}=NP_{C}=2306, where are positive integers respectively designating the number of turns in the partial primary windings/coils 10 to 15, and are NP_{A}, NP_{B} and NP_{C}, are positive integers designating the number of primary turns respectively calculated for the electrical phases ‘A’, ‘B’ and ‘C’.

In possible embodiments where three transformer blocks, Block1, Block2 and Block3, are coaxially and adjacently located in a side-by-side parallel relationship with the wide dimension faces of transformer block Block2 facing a wide dimension face of transformer block Block1 at one side thereof and a wide dimension face of transformer block Block3 at another side thereof, to form of a three-phase transformer having geometrical dimensions allowing it to be accommodated in a designated room e.g., a concrete locker of a wind electrical power station. In the example of a dry-type 630 kVA three-phase transformer having high voltage of U1=22 kV and low voltage of U2=0.4 kV, provided above, the three-phase transformer 10 can be assembled to assume the following geometrical dimensions and weight:
Height—1300 mm
Length 1210 mm
Width—760 mm
Weight—1350 kg

According to specifications of three-phase transformers e.g., as required by SGB-Sachsisch—Bayerische Starkstrom—Geratebau GmbH das Gemeinschaftsprojekt der SGB and TRR. The maximal allowable geometrical dimensions and weight of three-phase transformers, that can be installed in an existing concrete locker, are:
Height—1600 mm
Length 1250 mm
Width—850 mm
Weight—2300 kg.

Accordingly, three-phase transformer designs assembled according to embodiments of the present application can easily comply with the requirements expected from such transformers nowadays.

It is noted that the partial secondary and primary windings/coils can be connected to each other either in series or in parallel, regardless of the selected connection scheme used for connection to external three-phase power supply/load (triangle/star or star/triangle). The selection of serial or parallel connection between the coils depends in some embodiments on the selected operating voltages and, accordingly, the operating currents.

In three-phase transformer example provided above the input (high) voltage is 22 kV, and the output (low) voltage is 0.4 kV, and in this case the partial secondary and primary windings can be interconnected in series. However, in possible embodiments the input (high) voltage is 660 kV and the output (low) voltage is 0.4 kV, and in this case the partial primary and secondary windings must be interconnected in parallel.

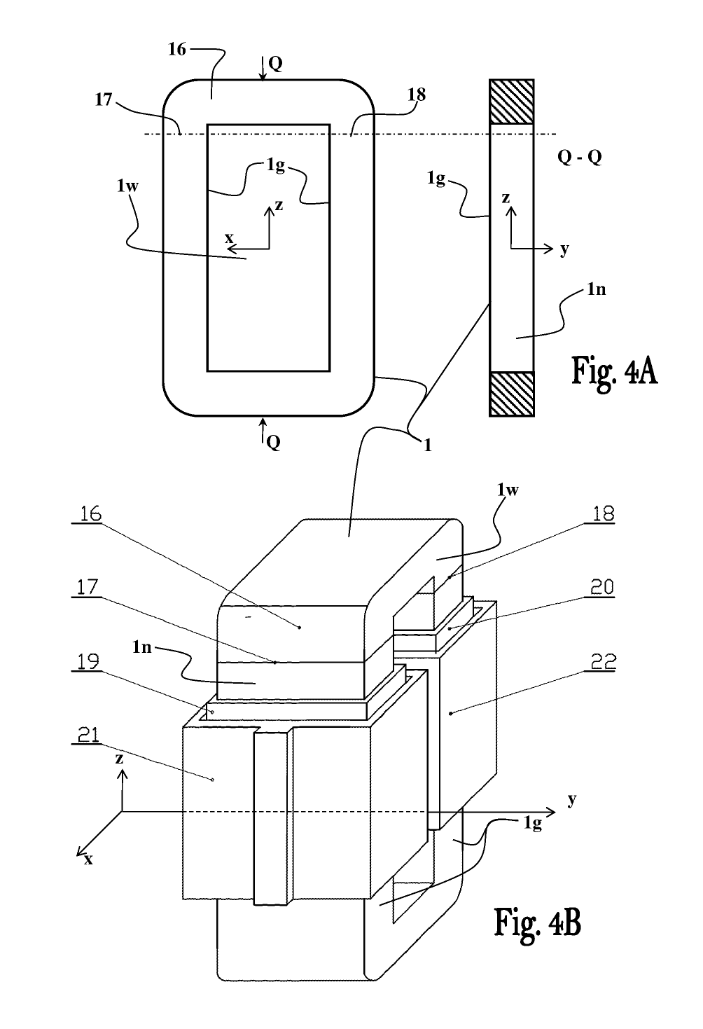

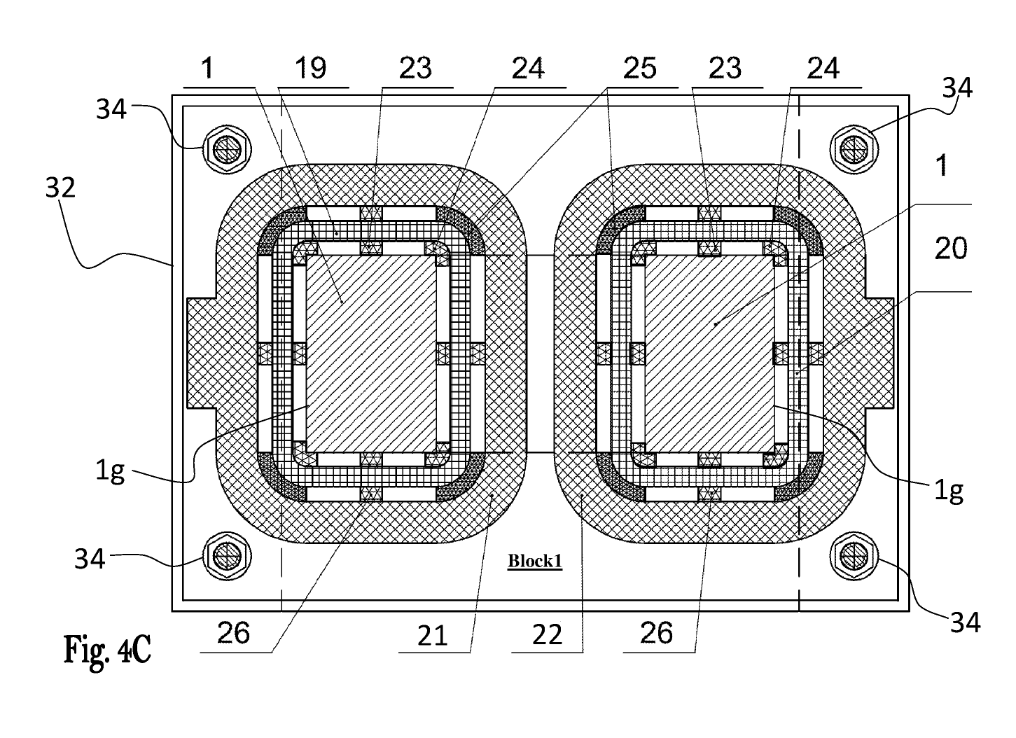

FIG. 4A shows front side sectional views of a closed-loop magnetic core element 1, according to some possible embodiments. The front view shows the wide dimension face 1w of the magnetic core element 1, and side-sectional view shows the narrow dimension face 1n of the magnetic core element 1. It is noted that the magnetic core element 1 of FIG. 4A and the magnetic core elements 1, 2 and 3, shown in FIGS. 2 and 3, are substantially of the same geometrical and structural properties, and can be prepared from the same materials using the same techniques. The magnetic core element 1 has a substantially rectangular ring shape having rounded external corners. In some embodiments, after the constructing the closed-loop magnetic core element 1, one of its sides is cut along cutting line 17-18, in order to open the closed-loop for placement of coils (19, 20, 21 and 22, in FIG. 4B) over the magnetic core legs 1g. Since the magnetic core legs 1g form major bases of the substantially rectangular ring shaped magnetic core element 1, the cutting 17-18 perform two at upper portion cuts, 17 and 18, in order to remove an upper minor base/side of the magnetic core element 1 for easily placing the windings/coils over the magnetic core legs 1g.

As shown in FIG. 4B, after performing the cuttings 17 and 18, removing the minor core side 16 of the magnetic core element 1, and placing partial winding/coils 19, 20, 21 and 22, over the magnetic core legs, the minor core side 16 is attached back (e.g., by fasteners/screws and/or brackets) to restore the rectangular ring shape and close the magnetic circuit of the magnetic core element 1. In this specific and non-limiting example the magnetic core element 1 comprises two different partial primary windings/coils, 21 and 22, and two different partial secondary windings/coils, 19 and 20, respectively associated with two different electrical phases of a three-phase electrical supply. Optionally, and in some embodiments preferably, windings/coils 19 and 21 are associated with one phase of the transformer, and windings/coils 20 and 22 are associated with another/different phase of the transformer. As seen, the partial primary/secondary windings/coils 19, 20, 21 and 22, are substantially distributed along the lengths of the magnetic core legs 1g.

Optionally, and in some embodiments preferably, in application where the high voltage is applied over the primary windings/coils, the inner partial windings/coils, 19 and 20, are partial secondary windings/coils, and the outer partial windings/coils, 21 and 22, are partial primary windings/coils. As demonstrated in FIGS. 2 and 3, the partial primary and secondary windings/coils of each magnetic core loop are respectively associated with two different electrical phases of the three-phase electrical supply, and respectively electrically connected in series to partial primary and secondary windings/coils respectively located in the two other magnetic core loops and respectively associated with the same two different electrical phases of the three-phase electrical supply.

FIG. 4C shows a cross-sectional view of the transformer block Block1 according to some possible embodiments. It is noted that the transformer block Block1 of FIG. 4C and the transformer blocks Block1, Block2 and Block3, shown in FIGS. 2 and 3, are substantially of the same geometrical and structural properties, and can be similarly assembled using same techniques.

As seen, electrically insulating spacers 23 and 24 are placed between the inner partial secondary windings/coils, 19 and 20, and the magnetic core legs 1g of the magnetic core loop 1, where the spacers 23 are placed on side surfaces of the legs 1g, and the spacers 24 are placed on corners of the legs 1g. Additional electrically insulating spacers 25 and 26 are placed between the primary and secondary windings/coils of each magnetic core leg 1g i.e., between windings/coils 19 and 21 and between windings/coils 20 and 22, where the spacers 26 are placed on external side surfaces of the inner windings/coils 19 and 20, and the spacers 25 are placed on corners of the of the inner windings/coils 19 and 20.

As also seen in FIG. 4C the transformer block Block1 is mounted on a base element 32 connected to an upper support (not shown) by fastening rods 34 e.g., by means of nuts bolt threads. In this specific and non-limiting example the cross-sectional shape of the windings/coils is substantially of rectangular ring shape with rounded corners to comply with the rectangular cross-sectional shape of the magnetic core elements.

FIG. 4D shows a three-phase transformer 40 assembled by mounting three transformer blocks of FIG. 4B side-by-side one parallel to the other. In this arrangement the closed-loop magnetic core elements 1, 2 and 3, of the transformer blocks, Block1, Block2 and block3, respectively, are coaxially spaced apart along a common axis (the ‘y’ axis) such that the planes of the closed-loop magnetic core elements are parallel one to the other, and their centers are aligned/coincide with the common axis.

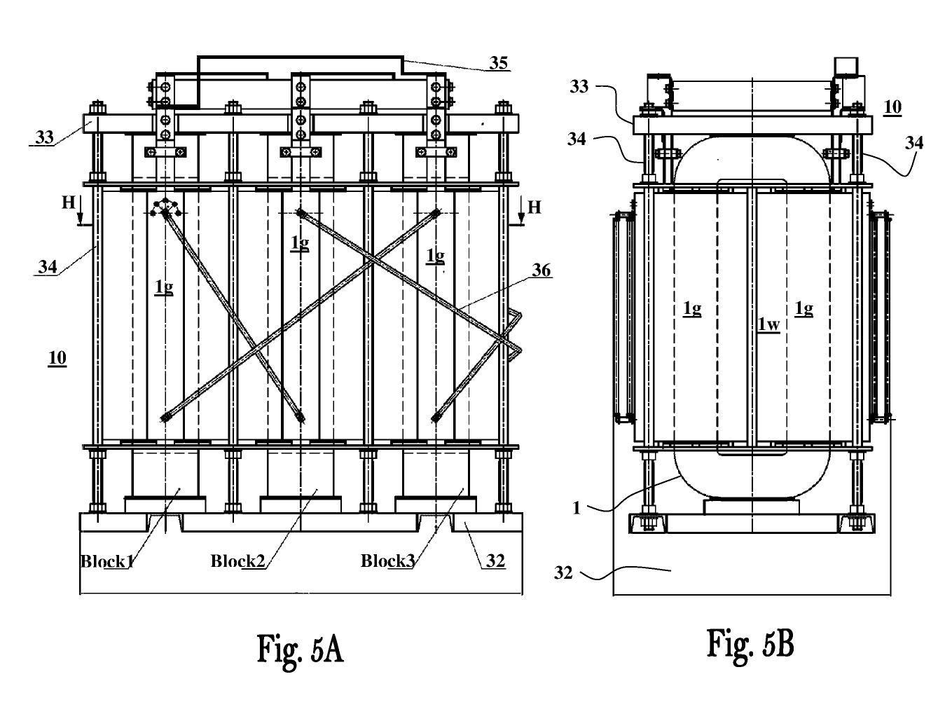

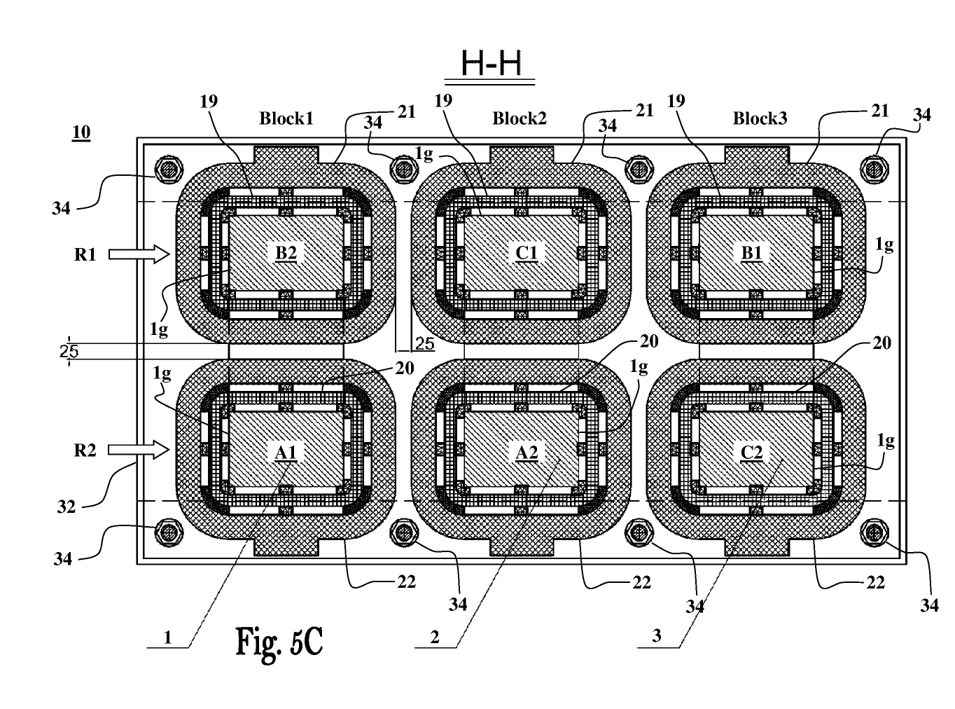

FIGS. 5A and 5B respectively show side and front views of a three-phase transformer 10, according to some possible embodiments wherein the transformer blocks are compactly and coaxially arranged side-by-side such that the wide-dimension faces of the closed-loop core elements are substantially parallel one to the other. As seen, the transformer blocks, Block1, Block2 and Block3, are vertically mounted between the common base 32 and the top support board 33, which are fixedly fastened one to the other by the fastening rods 34. In this specific and non-limiting example the electrical connection of the secondary windings/coils (as shown in FIG. 2) is established by bus bar elements 35 assembled above/on top of the top support board 33, and the electrical connection of the primary windings/coils (as shown in FIG. 3) is established by bus bar elements 36 passing along lateral sides of the three-phase transformer 10.

FIG. 5C shows a sectional view of the transformer 10 taken along the H-H arrowed lines shown in FIG. 5A. As seen, each magnetic core leg 1g of the transformer 10 is associated with a specific electric phase, and the magnetic core legs 1g of each transformer block are associated with different electrical phases. The coaxial arrangement of the transformer blocks side-by-side forms two parallel rows of magnetic core legs, R1 and R2, where two adjacently located magnetic core legs 1g from the rows R1 and R2 are magnetically coupled as being part of the same closed-loop magnetic core element.

In this particular and non-limiting example the magnetic core leg of the transformer block Block1 in row R1 is associated with electric phase ‘B’ (designated B2) and the magnetic core leg of the transformer block Block1 in row R2 is associated with electric phase ‘A’ (designated A1), the magnetic core leg of the transformer block Block2 in row R1 is associated with electric phase ‘C’ (designated C1) and the magnetic core leg of the transformer block Block2 in row R2 is associated with electric phase ‘A’ (designated A2), and the magnetic core leg of the transformer block Block3 in row R1 is associated with electric phase ‘B’ (designated B1) and the magnetic core leg of the transformer block Block3 in row R2 is associated with electric phase ‘C’ (designated C2).

As shown in FIGS. 2 and 3, the partial primary (outer, 21 and 22) and secondary (inner, 19 and 20) windings/coils placed over magnetic core legs associated with the same electric phase are electrically connected in series, such that the partial primary and secondary windings/coils on the magnetic core leg A1 are each respectively electrically connected in series to the partial primary and secondary windings/coils on the magnetic core leg A2, the partial primary and secondary windings/coils on the magnetic core leg B1 are each respectively electrically connected in series to the partial primary and secondary windings/coils on the magnetic core leg B2, and the partial primary and secondary windings/coils on the magnetic core leg C1 are each respectively electrically connected in series to the partial primary and secondary windings/coils on the magnetic core leg C2.

In this specific and non-limiting example distance between adjacently located external primary windings/coils is about 25 mm i.e., the distance between adjacently located primary windings/coils within each transformer block, and of adjacently located transformer blocks.

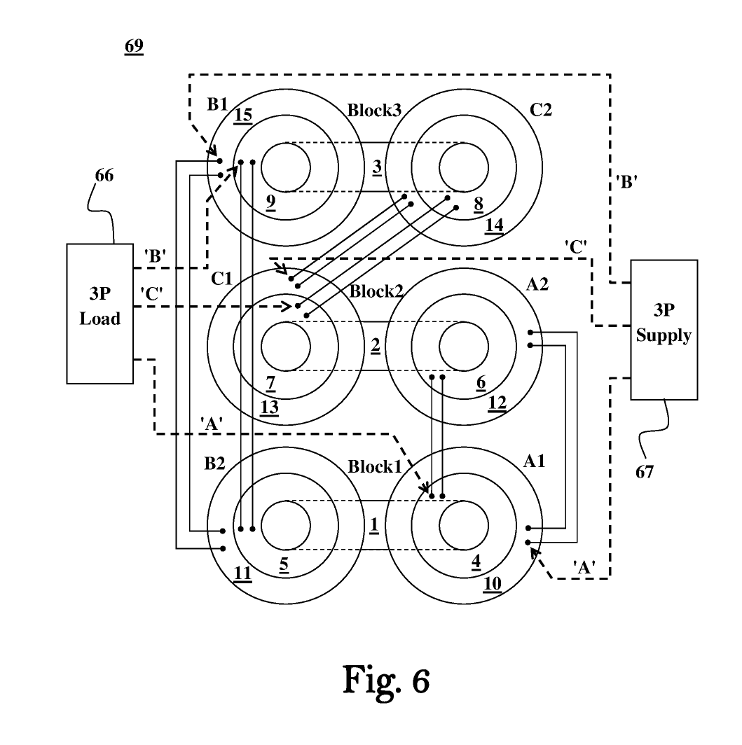

FIG. 6 schematically illustrates a three-phase transformer 69 wherein the partial primary and secondary windings associated with the same electrical phase are electrically connected in parallel. Accordingly, in this specific and non-limiting example:
the partial primary and secondary windings/coils, 10 and 4, associated with electric phase ‘A’ in the transformer block Block1, are respectively electrically connected in parallel to the partial primary and secondary windings/coils, 12 and 6, associated with electric phase ‘A’ in the transformer block Block2;
the partial primary and secondary windings/coils, 11 and 5, associated with electric phase ‘B’ in the transformer block Block1, are respectively electrically connected in parallel to the partial primary and secondary windings/coils, 15 and 9, associated with electric phase ‘B’ in the transformer block Block3; and
the partial primary and secondary windings/coils, 13 and 7, associated with electric phase ‘C’ in the transformer block Block2, are respectively electrically connected in parallel to the partial primary and secondary windings/coils, 14 and 8, associated with electric phase ‘C’ in the transformer block Block3.

The parallely connected partial primary windings/coils (10∥12), (11∥15) and (13∥14), can be electrically connected to form a delta circuit, as exemplified in FIG. 3, and the parallely connected partial secondary windings/coils (4∥6), (5∥9) and (7∥8), can be electrically connected to form a star circuit, as exemplified in FIG. 2. Alternatively, the partial primary windings/coils (10∥12), (11∥15) and (13∥14), can be electrically connected to form a star circuit, and the partial secondary windings/coils (4∥6), (5∥9) and (7∥8), can be electrically connected to form a delta circuit. For the sake of simplicity the delta/star connectivity of the windings/coils is not illustrated in FIG. 6.

As also seen in FIG. 6, the three-phase power supply 67 is connectable to the three-phase transformer 69 via partial primary windings/coil 10 connectable to electric phase ‘A’, partial primary windings/coil 15 connectable to electric phase ‘B’, and partial primary windings/coil 13 connectable to electric phase ‘C’. The three-phase load 66 is connectable to the three-phase transformer 69 via partial secondary windings/coil 4 connectable to electric phase ‘A’ of the load, partial secondary windings/coil 9 connectable to electric phase ‘B’ of the load, and partial primary windings/coil 7 connectable to electric phase ‘C’ of the load.

In the specific and non-limiting example shown in FIG. 6, the cross-sectional shape of the magnetic core elements in circular, and correspondingly, the partial primary and secondary coils are cylindrically shaped. It is however understood that any other suitable cross-sectional magnetic core shape can be used, and corresponding sectional shape of the windings/coils can be used, such as demonstrated herein.

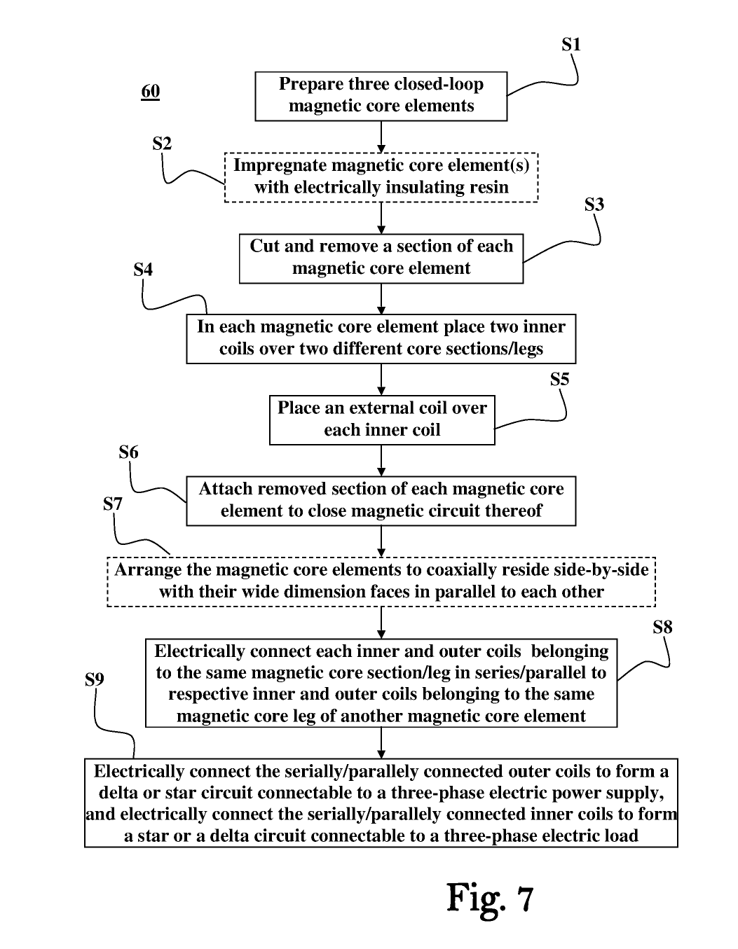

FIG. 7 is a flowchart showing a process 60 of preparing a three-phase transformer according to some possible embodiments. The starts in step S1 wherein three closed-loop magnetic core elements are prepared. The magnetic core elements can be fabricated by winding magnetic ribbon over a mandrel having a substantially circular, square or rectangular cross-sectional shape, or by any other suitable technique known in the art. In some embodiments the closed-loop magnetic core elements are fabricated from ribbon(s) made of ferromagnetic material such as, but not limited to, amorphous metal, amorphous alloy or nanocrystalline alloy, and/or silicon steel.

Next, in step S2, the closed-loop magnetic core elements are impregnated with an electrically insulating resin, such as, but not limited to, epoxy resin. Step S2 is an optional step and thus shown in a dashed-line box. In step S3 each magnetic core element is cut to remove a section/portion thereof and form an opening suitable for placing coils over sections of the magnetic core element, and in step S4 two inner coils are placed over two different core sections/legs of each magnetic core element through the opening formed in step S3. As shown in FIGS. 4C and 5C, in some embodiments a predetermined gap is maintained between each inner coil and its respective core section/leg e.g., by means of electrically insulating spacers. In step S5 an external coil is placed over each internal coil, via the opening formed in step S3. As shown in FIGS. 4C and 5C, in some embodiments a predetermined gap is maintained between each pair of inner and outer coils e.g., by means of electrically insulating spacers. Thereafter, in step S6, the core section that has been removed from each magnetic core element in step S3, is attached to its respective core element to restore its original closed-loop shape and close its magnetic circuit.

In step S7 the closed-loop magnetic core elements are arranged in a coaxial side-by-side relationship such that their wide dimension faces resides in parallel planes, to form a compact magnetic cores assembly for three-phase transformer. Step S7 is an optional step, shown by a dashed line box, since in alternative embodiments the closed-loop magnetic core elements can be located relatively remote one from the other, and in any suitable orientation in three-dimensional space i.e., not necessarily coaxially or side-by-side.

In step S8 the inner coil on each magnetic core section/leg is electrically connected either in series or in parallel to another inner coil located on a magnetic core section/leg of another closed-loop magnetic core element, and the respective outer coils located over these inner coils are also electrically connected in series or in parallel, respectively. In step S9 the serially or parallely connected outer coils are electrically connected to form a delta circuit electrically connectable to a three-phase electric power supply of the three-phase transformer, and the serially or parallely connected inner coils are electrically connected to form a star circuit electrically connectable to a three-phase load of the three-phase transformer. Alternatively, in some embodiments the serially or parallely connected outer coils are electrically connected to form a star circuit electrically connectable to a three-phase electric power supply of the three-phase transformer, and the serially or parallely connected inner coils are electrically connected to form a delta circuit electrically connectable to a three-phase load of the three-phase transformer.

Some noticeable advantages of the three-phase transformer embodiments are, inter alia:
substantial weight reduction, and substantial reduction of the magnetic losses in the magnetic core system of a three-phase transformer;
substantial reduction in the geometrical dimensions of the three-phase transformer due to being made from a set of separate independent transformer blocks coaxially disposed one adjacent to the other such that their wide dimension faces are parallel one to other while their vertical axes are in the same plane, or alternatively, one separated from the other by relatively large distances and in any suitable orientation;
the ability to place the three-phase transformer in locker having minimal geometrical dimensions; and
the ability to easily fit the three-phase transformer practically in any volume due to the ability of place the transformer blocks in any suitable distance and orientation, one relative to the other, in three-dimensional space.

In some embodiments, the number of transformer blocks may be larger than three, but a multiple of three e.g., 6, 9, 12, 24, etc. Thus, depending on the operating voltage and power, every three transformer blocks can be electrically connected in series, or in parallel, to a similar group of three transformer blocks and the weight of each transformer block can be thus decreases, respectively, by a factor 2, 3, 4 . . . 8, etc.

Terms such as top, bottom, front, back, right, and left, and similar adjectives in relation to orientation of the transformer blocks and/or their magnetic core elements, and components thereof, refer to the manner in which the illustrations are positioned on the paper, not as any limitation to the orientations in which the apparatus can be used in actual applications.

As described hereinabove and shown in the associated figures, the present application provides three-phase transformer designs, and related fabrication methods. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the claims.

1. A three-phase transformer comprising three closed-loop magnetic core elements each comprising two pairs of partial primary and secondary coils respectively associated with two different electrical phases of the three-phase transformer, each pair of partial primary and secondary coils is placed over a same magnetic core section of its closed-loop magnetic core element and its partial primary and secondary coils are respectively electrically connected either in series or in parallel to partial primary and secondary coils of another pair of partial primary and secondary coils associated with the same electrical phase and placed over another one of the closed-loop magnetic core elements, the serially or parallelly electrically connected partial primary coils are electrically coupled for connection to a three-phase electric power supply, and the serially or parallely electrically connected secondary coils are electrically coupled for connection to a three-phase load.

2. The three-phase transformer of claim 1 wherein the connected primary coils are electrically connected to each other to form a delta circuit electrically connectable to the three-phase electrical power supply, and the connected secondary coils are electrically connected to each other to form a star circuit electrically connectable to the three-phase load.

3. The three-phase transformer of claim 1 wherein the connected primary coils are electrically connected to each other to form a star circuit electrically connectable to the three-phase electrical power supply, and the connected secondary coils are electrically connected to each other to form a delta circuit electrically connectable to the three-phase load.

4. The three-phase transformer of claim 1 wherein the primary and secondary coils of each pair of partial primary and secondary coils are coaxially mounted one over the other.

5. The three-phase transformer of claim 4 wherein the in each pair of partial primary and secondary coils the primary coil is mounted over the secondary coil.

6. The three-phase transformer of claim 1 wherein the closed-loop magnetic core elements are positioned side-by-side one parallel to the other such that their wide dimension faces are substantially parallel to each other.

7. The three-phase transformer of claim 6 wherein the distance between adjacently located closed-loop frames is minimized to define a predetermined small gap between adjacently located partial coils.

8. The three-phase transformer of claim 7 wherein predetermined small gap between adjacently located partial coils is about 25 mm.

9. The three-phase transformer of claim 6 wherein each closed-loop magnetic core element has a substantially rectangular ring shape, and wherein said closed-loop magnetic core element are compactly arranged side-by-side one parallel to the other to form the three-phase transformer having a generally rectangular prism shape.

10. The three-phase transformer of claim 1 wherein the closed-loop magnetic core elements are placed relative remote one from the other.

11. The three-phase transformer of claim 1 wherein cross-sectional area of each closed-loop magnetic core element is half of a cross-sectional area computed for an electrical phase of a three-phase transformer designed to operate with same high and low voltages and electric currents according to standard specifications for three-phase transformers.

12. The three-phase transformer of claim 1 wherein the sum of turns in each of the serially or parallelly connected partial primary coils equals to a number of primary turns calculate for an electric phase of a three-phase transformer designed to operate with same high and low voltages and electric currents according to standard specifications for three-phase transformers, and wherein the sum of turns in each of the serially or parallelly connected partial secondary coils equals to a number of secondary turns calculate for the electric phase of the three-phase transformer designed to operate with same high and low voltages and electric currents according to the standard specifications for three-phase transformers.

13. The three-phase transformer of claim 12 wherein the number of turns in each partial primary coil is half of the calculated number of primary turns for the electrical phase of the three-phase transformer designed to operate with same high and low voltages and electric currents according to the standard specifications for three-phase transformers, and wherein the number of turns in each partial secondary coil is half of the calculated number of secondary turns for the electrical phase of the three-phase transformer designed to operate with same high and low voltages and electric currents according to the standard specifications for three-phase transformers.

14. The three-phase transformer of claim 1 wherein cross-sectional shape of the closed-loop magnetic core elements is rectangular.

15. The three-phase transformer of claim 14 wherein sectional shape of the coils is rectangular.

16. A three-phase transformer comprising two or more triplicates of transformer blocks, each triplicate of transformer blocks comprises partial primary and secondary coils arranged on closed-loop magnetic core elements and electrically connected as defined in claim 1, said two or more triplicates of transformer blocks are electrically coupled to each other to form either serial or parallel electrical connection between their coils.

17. A method of manufacturing a three-phase transformer, the method comprising preparing three closed-loop magnetic core elements, cutting and removing a section of each magnetic core element, placing two inner coils over two different core sections of each magnetic core element, placing an external coil over each inner coil, attaching to each magnetic core element its respective removed section, electrically connecting each inner and outer coils belonging to the same magnetic core section to respective inner and outer coils belonging to a same magnetic core section of another magnetic core element, electrically coupling between the outer coils for connection thereof to a three-phase power supply, and electrically coupling between the inner coils for connection thereof to a three-phase load.

18. The method of claim 17 comprising mounting the closed-loop magnetic core elements with their partial primary and secondary coils side-by-side one parallel and in proximity to the other.

19. The method of claim 17 comprising placing the closed-loop magnetic core elements with their partial primary and secondary coils one relative remote from the other.

20. The method of claim 17 wherein the preparing of the three closed-loop core elements comprises winding magnetic material ribbon.

21. The method of claim 17 wherein electrically coupling between the outer coils comprises electrically connecting the coils to form a delta circuit.

22. The method of claim 21 wherein electrically coupling between the inner coils comprises electrically connecting the coils to form a star circuit.

23. The method of claim 17 wherein electrically coupling between the outer coils comprises electrically connecting the coils to form a star circuit.

24. The method of claim 23 wherein electrically coupling between the inner coils comprises electrically connecting the coils to form a delta circuit.

25. The method of claim 17 comprising impregnating the closed-loop magnetic core elements with a resin material.

26. The method of claim 17 comprising placing electrically insulting spacers between the inner and outer coils.
